(19) United States
(12) Patent Application Publication
(10) Pub. No.: US 2019/0384678 A1
(43) Pub. Date: Dec. 19, 2019

(54) SYSTEM AND METHOD FOR MANAGING BACKUP AND RESTORE OF OBJECTS OVER CLOUD PLATFORMS

(71) Applicant: Nutanix, Inc., San Jose, CA (US)

(72) Inventors: Ravikanth Samprathi, San Jose, CA (US); Chhavi Upadhyay, San Jose, CA (US); Hemanth Kumar Mantri, San Jose, CA (US); James Sodini, San Jose, CA (US); Akshay Khole, San Jose, CA (US); Uzli Li, San Jose, CA (US); Ray Xie, San Jose, CA (US); Srinivas Bandi Ramesh Babu, Mountain View, CA (US)

(21) Appl. No.: 16/008,258

(22) Filed: Jun. 14, 2018

(51) Int. Cl. G06F 11/14; G06F 17/30; G06F 9/455

(52) U.S. Cl. CPC G06F 11/1464; G06F 11/1469; G06F 17/30088; G06F 2009/45583; G06F 2201/84; G06F 2009/45595; G06F 9/45558

(57) ABSTRACT

A system and method include providing backup and restore capability to a cluster node. The cluster node includes a controller virtual machine (CVM) that is communicably coupled to a plurality of cloud platforms and provides the capability of carrying out backup and restore at the cloud platforms without having to run a CVM at the cloud platform. The CVM can backup objects to the cloud platform and store metadata information related to the object in storage. The CVM also takes snapshots of the object and stores the snapshots. The CVM also determines a changed data chunks that include the changes made to the object from the last snapshot. To restore the object, the CVM restores the object based, in part, on the snapshots, the changed data chunks, and the metadata stored at the node.

### BACKGROUND

The following description is provided to assist the understanding of the reader. None of the information provided or references cited is admitted to be prior art.

Virtual computing systems are widely used in a variety of applications. Virtual computing systems include one or more host machines running one or more virtual machines concurrently. The one or more virtual machines utilize the hardware resources of the underlying one or more host machines. Each virtual machine may be configured to run an instance of an operating system. Modern virtual computing systems allow several operating systems and several software applications to be safely run at the same time on the virtual machines of a single host machine, thereby increasing resource utilization and performance efficiency. However, present day virtual computing systems still have limitations due to their configuration and the way they operate.

### SUMMARY

In accordance with at least some aspects of the present disclosure, a method is disclosed. The method includes receiving, by a computing system, a request to back up an object to a cloud platform from a plurality of cloud platforms. The method further includes generating, by the computing system, a snapshot of the object. The method also includes generating, by the computing system, at least one changed data chunk including changed data blocks in the object with respect to a previous snapshot of the object. The method additionally includes creating, by the computing system, at the cloud platform, a bucket, and uploading, by the computing system, the object and the at least one changed data chunk to the bucket. The method further includes receiving, by the computing system, from the cloud platform, a response header including a plurality of version IDs corresponding to the object and to the at least one changed data chunk. The method further includes generating, by the computing system, metadata associated with the object, the metadata including the plurality of version IDs. The method also includes storing, by the computer system, the metadata associated with the object at a storage in the computer system. The method additionally includes receiving, by the computing system, a request to restore the object and restoring, by the computing system, the object based on the metadata and the bucket.

In accordance with some other aspects of the present disclosure, a method is disclosed. The method includes receiving, at a computer system, a request to restore a backed up object stored on a cloud platform, the computer system and the cloud platform communicably coupled to the cloud platform over a computer network. The method further includes communicating, by the computer system, with the cloud platform over the computer network to create at least one new file with a copy of a previous snapshot associated with the backed up object at the cloud platform. The method also includes identifying, by the computer system, changed data chunks associated with the backed up object stored in the cloud platform. The method additionally includes communicating, by the computer system, with the cloud platform over the computer network to merge the changed chunks with the at least one new file to generate a restored object. The method also includes communicating, by the computer system, with the cloud platform over the computer network to transfer the restored object to a requested destination.

In accordance with some other aspects of the present disclosure, a system is disclosed. The system manages a cloud computing environment and includes a controller communicably coupled to a plurality of cloud platforms. The controller is configured to receive a request to back up an object to a cloud platform from a plurality of cloud platforms. The controller is further configured to generate a snapshot of the object, and to generate at least one changed data chunk including changed data blocks in the object with respect to a previous snapshot of the object. The controller is configured to create at the cloud platform, a bucket and to upload the object and the at least one changed data chunk to the bucket. The controller is also configured to receive from the cloud platform, a response header including a plurality of version IDs corresponding to the object and to the at least one changed data chunk. The controller is further configured to generate metadata associated with the object, the metadata including the plurality of version IDs, and to store the metadata associated with the object at a data storage at the controller. The controller is also configured to receive a request to restore the object and to restore the object based on the metadata and the bucket.

In accordance with some other aspects of the present disclosure, a system is disclosed. The system manages a cloud computing environment and includes a controller communicably coupled to a plurality of cloud platforms. The controller is configured to receive a request to restore a backed up object stored on a cloud platform of the plurality of cloud platforms, the computer system and the cloud platform communicably coupled to the cloud platform over a computer network. The controller is further configured to communicate with the cloud platform over the computer network to create at least one new file with a copy of a previous snapshot associated with the backed up object at the cloud platform. The controller is also configured to identify changed data chunks associated with the backed up object stored in the cloud platform. The controller is also configured to communicate with the cloud platform over the computer network to merge the changed chunks with the at least one new file to generate a restored object. The controller is additionally configured to communicate with the cloud platform over the computer network to transfer the restored object to a requested destination.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is a block diagram of a virtual computing system, in accordance with some embodiments of the present disclosure.

FIG. 2 shows additional details of the virtual computing system shown in FIG. 1, in accordance with some embodiments of the present disclosure.

FIG. 3 shows a flow diagram of an example process for storing objects for the first time in a cloud platform, in accordance with some embodiments of the present disclosure.

FIG. 4 shows an example object metadata that can be stored by the backup and restore layer, in accordance with some embodiments of the present disclosure.

FIG. 5 shows a flow diagram of an example process for processing subsequent requests for backing up objects, in accordance with some embodiments of the present disclosure.

FIG. 6 shows an example updated metadata associated with an object, in accordance with some embodiments of the present disclosure.

FIG. 7 shows a flow diagram of an example process for restoring objects.

FIG. 8 shows an example object metadata and example process flow at the cloud platform for restoring an object, in accordance with an embodiment of the present disclosure.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure is generally directed to backup and restore of virtual machine objects, such as virtual machines, snapshot, clone, image, volume, and disk. These virtual machine objects can be run or executed on a node or cluster. For example, a node can include a hypervisor that can run a number of user VMs and provide hardware and memory resources to the user VMs. The user virtual machines emulate the functionality of a physical computer and may run their own operating system and applications on underlying physical resources virtualized by the hypervisor. In some implementations, the user VMs may be run on a cloud platform. Due to hardware or software failure, the virtual machines, as well as other virtual machine objects virtualized by the hypervisor, may be lost. To reduce the risk of such loss, the virtual machine objects can be backed up so that they can be restored in case of a data loss event. The backups of the virtual machine objects can be stored in a cloud platform, such as a private cloud platform or a public cloud platform. When a restore of a virtual machine object is requested, the corresponding backed up virtual machine object can be retrieved from the public or cloud platform and processed.

One technical problem associated with the backup and restore process is that the cloud platform may not be capable of providing disaster recovery services. That is, the cloud platform may only provide the ability to store the backups of the virtual machine objects, but may not allow restoration of the virtual machine objects. Thus, the backed up data would have to be moved to a different location to be restored. This can increase the downtime of the computing system relying on the virtual machine objects to be restored. Another technical problem associated with the backup and restore process is that even if a cloud platform may provide disaster recovery services, restoration is typically limited to the same cloud platform. Thus, if the cloud platform itself is unreliable, then limiting the restoration to the unreliable cloud platform may reduce the reliability and availability of the virtual machine objects.

The discussion below provides at least one technical solution to the technical problems discussed above. For example, the disaster recovery service is provided at the cluster or node instead of on the cloud platform. This allows restoration of the virtual machine objects from one public cloud platform to another public cloud platform. A backup and restore layer is provided at the cluster in a private cloud platform. The backup and restore layer maintains a stateful representation of each virtual machine object within the cluster. When a backup is requested, a snapshot of the virtual machine objects is captured and the snapshot is transferred to a public cloud for storage. When a restore operation is requested, the virtual machine object is restored from the snapshot stored in the public cloud. The backup and restore layer describes and stores the metadata in such a manner that the virtual machine objects can be restored on any cloud platform, and not just the cloud platform on which the snapshots are stored. As a result, the reliability and availability of the computing system is improved.

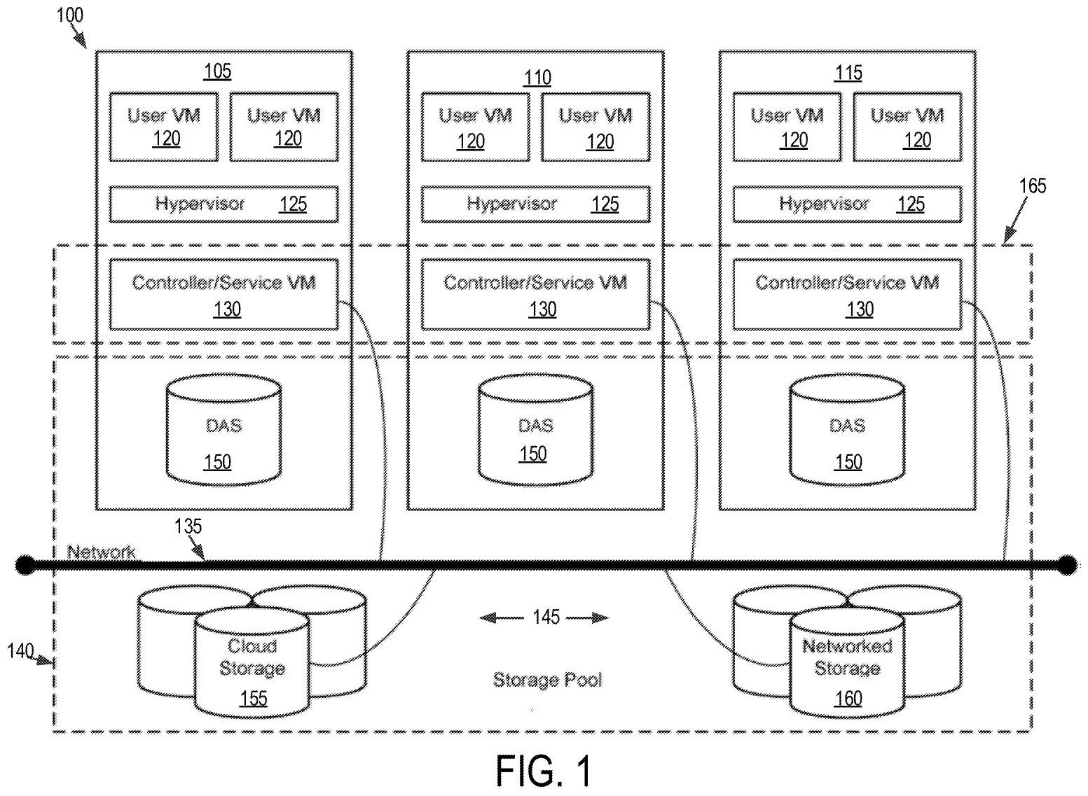

Referring now to FIG. 1, a virtual computing system 100 is shown, in accordance with some embodiments of the present disclosure. The virtual computing system 100 may be part of a datacenter. The virtual computing system 100 includes a plurality of nodes, such as a first node 105, a second node 110, and a third node 115. Each of the first node 105, the second node 110, and the third node 115 includes user virtual machines (VMs) 120 and a hypervisor 125 configured to create and run the user VMs. Each of the first node 105, the second node 110, and the third node 115 also includes a controller/service VM 130 that is configured to manage, route, and otherwise handle workflow requests to and from the user VMs 120 of a particular node. The controller/service VM 130 is connected to a network 135 to facilitate communication between the first node 105, the second node 110, and the third node 115. Although not shown, in some embodiments, the hypervisor 125 may also be connected to the network 135.

The virtual computing system 100 may also include a storage pool 140. The storage pool 140 may include network-attached storage 145 and direct-attached storage 150. The network-attached storage 145 may be accessible via the network 135 and, in some embodiments, may include cloud storage 155, as well as local storage area network 160. In contrast to the network-attached storage 145, which is accessible via the network 135, the direct-attached storage 150 may include storage components that are provided within each of the first node 105, the second node 110, and the third node 115, such that each of the first, second, and third nodes may access its respective direct-attached storage without having to access the network 135.

It is to be understood that only certain components of the virtual computing system 100 are shown in FIG. 1. Nevertheless, several other components that are commonly provided or desired in a virtual computing system are contemplated and considered within the scope of the present disclosure. Additional features of the virtual computing system 100 are described in U.S. Pat. No. 8,601,473, the entirety of which is incorporated by reference herein.

Although three of the plurality of nodes (e.g., the first node 105, the second node 110, and the third node 115) are shown in the virtual computing system 100, in other embodiments, greater or fewer than three nodes may be used. Likewise, although only two of the user VMs 120 are shown on each of the first node 105, the second node 110, and the third node 115, in other embodiments, the number of the user VMs on the first, second, and third nodes may vary to include either a single user VM or more than two user VMs. Further, the first node 105, the second node 110, and the third node 115 need not always have the same number of the user VMs 120. Additionally, more than a single instance of the hypervisor 125 and/or the controller/service VM 130 may be provided on the first node 105, the second node 110, and/or the third node 115.

Further, in some embodiments, each of the first node 105, the second node 110, and the third node 115 may be a hardware device, such as a server. For example, in some embodiments, one or more of the first node 105, the second node 110, and the third node 115 may be an NX-1000 server, NX-3000 server, NX-6000 server, NX-8000 server, etc. provided by Nutanix, Inc. or server computers from Dell, Inc., Lenovo Group Ltd. or Lenovo PC International, Cisco Systems, Inc., etc. In other embodiments, one or more of the first node 105, the second node 110, or the third node 115 may be another type of hardware device, such as a personal computer, an input/output or peripheral unit such as a printer, or any type of device that is suitable for use as a node within the virtual computing system 100.

Each of the first node 105, the second node 110, and the third node 115 may also be configured to communicate and share resources with each other via the network 135. For example, in some embodiments, the first node 105, the second node 110, and the third node 115 may communicate and share resources with each other via the controller/service VM 130 and/or the hypervisor 125. One or more of the first node 105, the second node 110, and the third node 115 may also be organized in a variety of network topologies, and may be termed as a “host” or “host machine.”

Also, although not shown, one or more of the first node 105, the second node 110, and the third node 115 may include one or more processing units configured to execute instructions. The instructions may be carried out by a special purpose computer, logic circuits, or hardware circuits of the first node 105, the second node 110, and the third node 115. The processing units may be implemented in hardware, firmware, software, or any combination thereof. The term “execution” is, for example, the process of running an application or the carrying out of the operation called for by an instruction. The instructions may be written using one or more programming language, scripting language, assembly language, etc. The processing units, thus, execute an instruction, meaning that they perform the operations called for by that instruction.

The processing units may be operably coupled to the storage pool 140, as well as with other elements of the respective first node 105, the second node 110, and the third node 115 to receive, send, and process information, and to control the operations of the underlying first, second, or third node. The processing units may retrieve a set of instructions from the storage pool 140, such as, from a permanent memory device like a read only memory (ROM) device and copy the instructions in an executable form to a temporary memory device that is generally some form of random access memory (RAM). The ROM and RAM may both be part of the storage pool 140, or in some embodiments, may be separately provisioned from the storage pool. Further, the processing units may include a single stand-alone processing unit, or a plurality of processing units that use the same or different processing technology.

With respect to the storage pool 140 and particularly with respect to the direct-attached storage 150, it may include a variety of types of memory devices. For example, in some embodiments, the direct-attached storage 150 may include, but is not limited to, any type of RAM, ROM, flash memory, magnetic storage devices (e.g., hard disk, floppy disk, magnetic strips, etc.), optical disks (e.g., compact disk (CD), digital versatile disk (DVD), etc.), smart cards, solid state devices, etc. Likewise, the network-attached storage 145 may include any of a variety of network accessible storage (e.g., the cloud storage 155, the local storage area network 160, etc.) that is suitable for use within the virtual computing system 100 and accessible via the network 135. The storage pool 140 including the network-attached storage 145 and the direct-attached storage 150 may together form a distributed storage system configured to be accessed by each of the first node 105, the second node 110, and the third node 115 via the network 135 and the controller/service VM 130, and/or the hypervisor 125. In some embodiments, the various storage components in the storage pool 140 may be configured as virtual disks for access by the user VMs 120.

Each of the user VMs 120 is a software-based implementation of a computing machine in the virtual computing system 100. The user VMs 120 emulate the functionality of a physical computer. Specifically, the hardware resources, such as processing unit, memory, storage, etc., of the underlying computer (e.g., the first node 105, the second node 110, and the third node 115) are virtualized or transformed by the hypervisor 125 into the underlying support for each of the plurality of user VMs 120 that may run its own operating system and applications on the underlying physical resources just like a real computer. By encapsulating an entire machine, including CPU, memory, operating system, storage devices, and network devices, the user VMs 120 are compatible with most standard operating systems (e.g. Windows, Linux, etc.), applications, and device drivers. Thus, the hypervisor 125 is a virtual machine monitor that allows a single physical server computer (e.g., the first node 105, the second node 110, third node 115) to run multiple instances of the user VMs 120, with each user VM sharing the resources of that one physical server computer, potentially across multiple environments. By running the plurality of user VMs 120 on each of the first node 105, the second node 110, and the third node 115, multiple workloads and multiple operating systems may be run on a single piece of underlying hardware computer (e.g., the first node, the second node, and the third node) to increase resource utilization and manage workflow.

The user VMs 120 are controlled and managed by the controller/service VM 130. The controller/service VM 130 of each of the first node 105, the second node 110, and the third node 115 is configured to communicate with each other via the network 135 to form a distributed system 165. The hypervisor 125 of each of the first node 105, the second node 110, and the third node 115 may be configured to run virtualization software, such as, ESXi from VMWare, AHV from Nutanix, Inc., XenServer from Citrix Systems, Inc., etc., for running the user VMs 120 and for managing the interactions between the user VMs and the underlying hardware of the first node 105, the second node 110, and the third node 115. The controller/service VM 130 and the hypervisor 125 may be configured as suitable for use within the virtual computing system 100.

The network 135 may include any of a variety of wired or wireless network channels that may be suitable for use within the virtual computing system 100. For example, in some embodiments, the network 135 may include wired connections, such as an Ethernet connection, one or more twisted pair wires, coaxial cables, fiber optic cables, etc. In other embodiments, the network 135 may include wireless connections, such as microwaves, infrared waves, radio waves, spread spectrum technologies, satellites, etc. The network 135 may also be configured to communicate with another device using cellular networks, local area networks, wide area networks, the Internet, etc. In some embodiments, the network 135 may include a combination of wired and wireless communications.

Referring still to FIG. 1, in some embodiments, one of the first node 105, the second node 110, or the third node 115 may be configured as a leader node. The leader node may be configured to monitor and handle requests from other nodes in the virtual computing system 100. If the leader node fails, another leader node may be designated. Furthermore, one or more of the first node 105, the second node 110, and the third node 115 may be combined together to form a network cluster (also referred to herein as simply “cluster.”) Generally speaking, all of the nodes (e.g., the first node 105, the second node 110, and the third node 115) in the virtual computing system 100 may be divided into one or more clusters. One or more components of the storage pool 140 may be part of the cluster as well. For example, the virtual computing system 100 as shown in FIG. 1 may form one cluster in some embodiments. Multiple clusters may exist within a given virtual computing system (e.g., the virtual computing system 100). The user VMs 120 that are part of a cluster may be configured to share resources with each other.

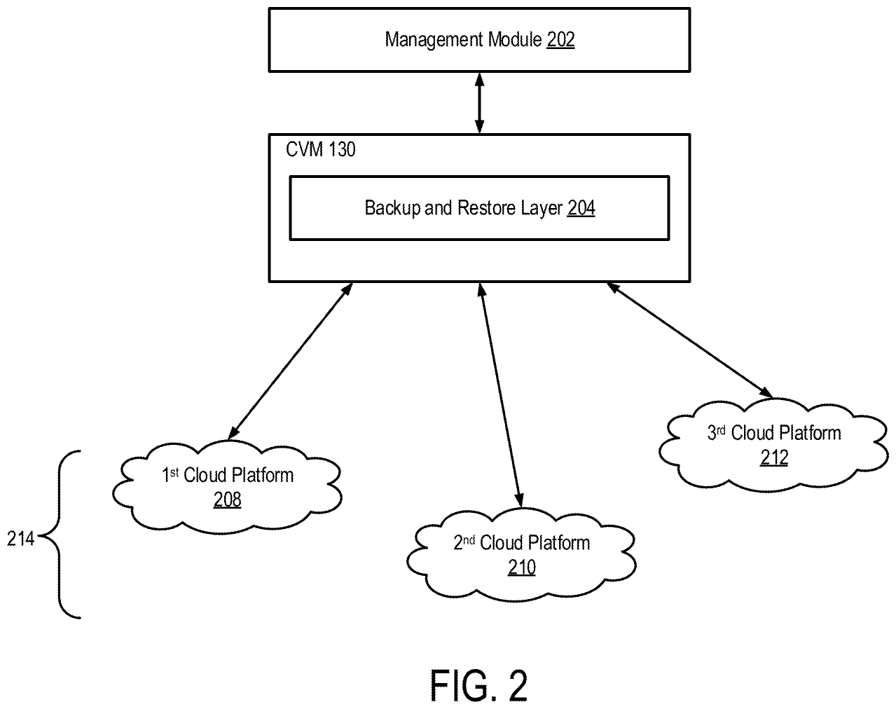

FIG. 2 shows additional details of the virtual computing system 100 shown in FIG. 1. In particular, the CVM 130 includes a backup and restore layer 204, which can communicate with a first cloud platform 208, a second cloud platform 210, and a third cloud platform 212 (collectively referred to as “the cloud platforms 214”) and a management module 202. The backup and restore layer 204 can provide backup and restore functionality as a service to any entity within the virtual computing system 100. That is, the backup and restore layer 204 can provide an application program interface or a user interface to allow programs or users on the virtual computing system 100 to request for backup and restore operations pertaining to various objects within the virtual computing system 100. The objects can include, for example, the user VMs 120, images, volumes, disks, snapshots, or any other data objects within the virtual computing system 100. As discussed further below, the backup and restore layer 204 can provide the ability to backup objects to one of the cloud platforms 214 and to restore the objects to the same one or another one of the cloud platforms 214.

The cloud platforms 214 can include public cloud platforms, private cloud platforms, and hybrid cloud platforms. Public cloud platforms include those platforms where cloud resources (such as servers and storage) are operated by a third-party cloud service provider and delivered over a network, such as the Internet. With a public cloud, all hardware, software, and other supporting infrastructure is owned and managed by the cloud service provider. Examples of public cloud platforms can include, without limitation, Amazon S3 (Simple Storage Service), Microsoft Azure, Google Cloud Platform, Nutanix Acropolis, and the like. Private cloud platforms include those platforms where the cloud resources are exclusively owned and operated by one business or organization. The cloud resources may be physically located at the organization's on-site data center, or can be located at a third-party service provider. But, the cloud resources, services, and resources are maintained on a private network. Hybrid clouds can combine on-premises infrastructure of private clouds with public clouds. Data and applications can be moved between the private and public clouds, which provides greater flexibility and deployment options.

Each one of the cloud platforms 214 can provide an interface in the form of a user interface and/or an application programming interface (API), that a user or a program can utilize to access the services provided by the cloud platforms. For example, the Amazon S3 provides a set of S3 REST APIs to initiate and execute the services offered by the cloud platform. The backup and restore layer 204 can be configured to communicate with a particular cloud platform using the API associated with that cloud platform.

The management module 202 can include a program or service for managing the objects at the node, such as the first, second, and third nodes 105, 110, and 115. The management module 202 can manage objects such as VMs, images, volume groups, disks, and other objects. The management module 202 can send requests or communication to the CVM 130 to request backup and restore operations on the one or more objects.

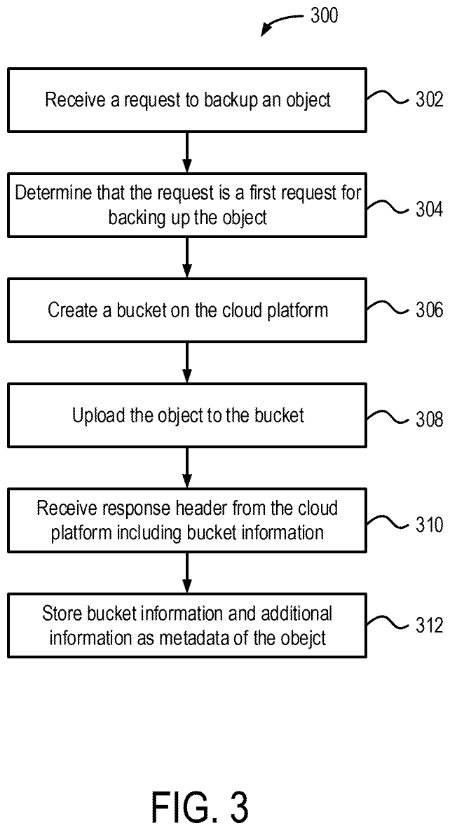

In one or more embodiments, the backup and restore layer 204 can include an API server, such as a REST API server, that can receive backup and restore requests from the management module 202. In response, the backup and restore layer 204 can perform several operations that can backup and restore objects to and from the cloud platforms 214. FIG. 3 shows a flow diagram of an example process 300 for storing objects for the first time in a cloud platform. Additional, fewer, or different operations may be performed depending on the implementation. For example, the backup and restore layer 204 can receive a request to back up an object such as a VM, an image, a volume, a disk, a snapshot, a clone, and the like to one of the cloud platforms 214 (operation 302). An object can refer to individual pieces of data that can be stored on the cloud platforms. For example, an object can refer to a file that is stored on the cloud platforms 214. The object may not have a size limit associated with it. However, in some instances, a size limit set by a cloud platform may affect the size of the data that can be backed up per iteration. Each object can have object data and object metadata associated with it. The object data can include the actual data, such as the file data, that is to be stored, while the object metadata can include a collection of name-value pairs that describe the object. For example, an Amazon S3 object can include object data, an object key, and object metadata. The object key uniquely identifies the object. For example, the object key can include a unique ID. Object metadata can include a set of name-value pairs, the values of which can be set when the object is uploaded to the cloud platform.

When the backup and restore layer 204 receives a request for backing up an object, the request can include an identity of the object. For example, the request can include the object key or unique ID of the object. Responsive to receiving a request, the backup and restore layer 204 can determine whether the backup request for the particular object is the first backup of that object or whether previous backups of the same object have been carried out (operation 304). The backup and restore layer 204 can determine whether a bucket matching the unique ID of object key of the requested object is present on the cloud platform. If no bucket matching the unique ID or object key is present, the backup and restore layer 204 can determine that the requested object is being backed up for the first time. As a result, the backup and restore layer 204 can back up the entire object to the cloud platform.

The backup and restore layer 204 can create a bucket in on the cloud platform to store the object (operation 306). A bucket refers to storage containers, or a storage space, on the cloud platform within which objects can be stored. The cloud platform may specify that a bucket be created on the cloud platform, before storing the objects within the buckets. The backup and restore layer 204 can utilize an API provided by the cloud platform to create a bucket. For example, if the bucket is created on the Amazon S3 cloud platform, the backup and restore layer 204 can use the Amazon S3 REST API or the AWS software development kit (SDK) to create the bucket. The backup and restore layer 204 can configure the bucket to have a name or a key that is same as the object key or unique ID of the object. In addition, the backup and restore layer 204 can configure the bucket to enable versioning for the bucket. Enabling versioning helps recovering objects from accidental overwrites or deletes.

After creating the bucket on the cloud platform, the backup and restore layer 204 can upload the object to the bucket (operation 308). The backup and restore layer 204 can utilize the API provided by the cloud platform to upload the object to the bucket. In some instances, the size of the object may dictate the number of uploads needed to the upload the entire object to the bucket. For example, if the size of the object is more than 5 GB, and the cloud platform is the Amazon S3 cloud platform, then the backup and restore layer 204 can use multiple uploads of at most 5 GB each.

Responsive to creating the bucket and/or uploading the object to the bucket, the backup and restore layer 204 can receive from the cloud platform an acknowledgement, which can include a response header (operation 310). For example, if the cloud platform is Amazon S3, the backup and restore layer 204 can receive an “x-amz-versionid” response header, which can include the value of the version ID associated with the uploaded object.

The backup and restore layer 204 can store the received version ID in correspondence with a snapshot ID of the object that was uploaded. This provides a mapping between the snapshot ID and the version ID of the object stored in the bucket. The backup and restore layer 204 can store snapshot IDs of all the objects that are uploaded to the cloud platform, and, in addition, can store the corresponding version IDs received in the response headers from the cloud platform. In addition, the backup and restore layer 204 can store the corresponding size of the file of the object as well as the time the snapshot of the object was taken in association with the snapshot ID of the object. In one embodiment, the backup and restore layer 204 can store the snapshot ID, the version ID, size of the file, as well as the time of snapshot at the cluster or the private cloud as metadata associated with the object (operation 312).

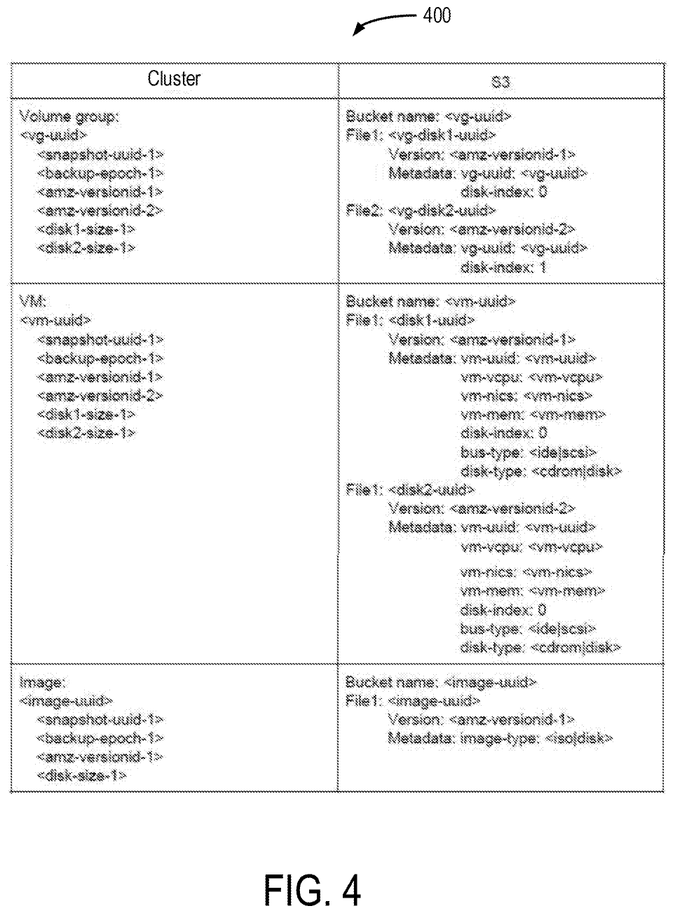

FIG. 4 shows an example object metadata 400 that can be stored by the backup and restore layer 204. In particular, the FIG. 4 shows metadata associated with objects such as volume group, VM, and image. However, it is understood that metadata associated with other objects also can be stored. The metadata includes data received from the Amazon S3 cloud platform in the right hand column. Again, this is only an example, and that the data from other cloud platforms, instead of from the Amazon S3 cloud platform, can be included in the right hand column if the objects are stored in that cloud platform. In the left column, for each object, the backup and restore layer 204 can store the unique ID or key of the object (“vg-uuid”), and associated snapshot ID (“<snapshot-uuid-1”), the time of the snapshot (“backup-epoch-1”), the version ID of the object stored in the bucket (“amz-versionid-1” and “amz-versionid-2”), and the size of the file (“disk1-size-1” and “disk2-size-1”).

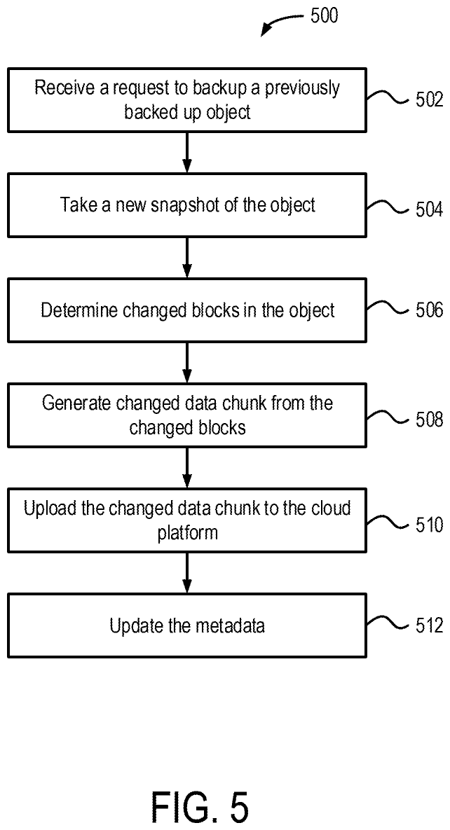

The backup and restore layer 204 can receive, from the management module 202, subsequent requests to back up the same object. FIG. 5 shows a flow diagram of an example process 500 for processing subsequent requests for backing up objects. Additional, fewer, or different operations may be performed depending on the implementation. The process 500 includes the backup and restore layer 204 receiving a subsequent request to back up the object (operation 502). The backup and restore layer 204 may determine whether the received request is to back up a new object or one already backed up by looking up the unique ID or key associated with the object, and included in the request, with the list of objects that have already been backed up. If there is a match, the backup and restore layer 204 can determine that the received request is a subsequent request to back up a previously backed up object. Responsive to the request for a subsequent backup of an object that already exists in the cloud platform, the backup and restore layer 204 can take a new snapshot of the object (operation 502).

The backup and restore layer 204 then determines the blocks within the object that have changed (operation 504). The backup and restore layer 204 can call a changed block tracking (CBT) routine or service to determine the blocks that have changed. The CBT routine or service can return a set of regions within the object that have changed blocks, along with their location, and their size. The CBT routine can determine the changed blocks by comparing the current snapshot of the object with a previously stored snapshot of the object.

The backup and restore layer 204 can accumulate the changed blocks into a changed data chunk (operation 506). The changed data chunk can include all the changed blocks and the related information received from the CBT routine. The backup and restore layer 204 can upload the changed data chunk to the cloud platform (operation 508). In particular, the backup and restore layer 204 uploads the changed data chunk to the same bucket that includes the associated object. As the bucket is version enabled, the cloud platform assigns a new version ID to the uploaded changed data chunks. The cloud platform can return the new version IDs in response to the uploading of the changed data chunks.

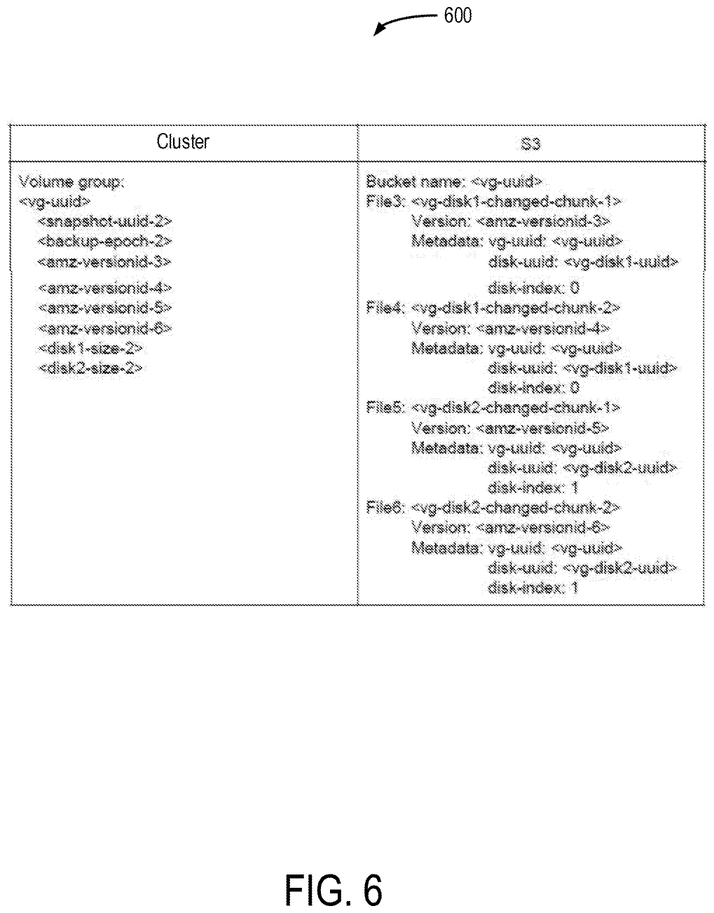

The backup and restore layer 204 can update the metadata stored in the cluster with the version IDs received from the cloud platform (operation 510). FIG. 6 shows an example updated metadata 600 associated with an object. In particular, FIG. 6 shows the metadata associated with a second snapshot or backup of the volume group object shown in FIG. 4. The backup and restore layer 204 stores in the cluster, metadata associated with the second snapshot or backup of the volume group shown in FIG. 4. In particular, the backup and restore logic stores unique id “<snapshot-uuid-2>” associated with the second snapshot of the volume group. The backup and restore layer 204 also stores the time at which the second snapshot is taken, denoted by the value “<backup-epoch-3>.” For example, the metadata associated with the volume group stored in the cluster includes updated version IDs corresponding to the uploaded changed data chunks. The version ID “<amz-versionid-3>” corresponds to the “changed-chunk-1,” which is stored in “File-3” in the bucket with the same uuid as the volume group in the cluster. Similarly, the version ID “<amz-versionid-4>” corresponds to the “changed-chunk-2,” which is stored in “File-4” in the same bucket as “File-3”. It should be noted that both “File-3” and “File-4” have the same “disk-index” value “0”. This indicates that “File-3” and “File-4” represent changed chunks with respect to “File-1,” which is the first snapshot stored in the bucket, and shown in FIG. 4. The number of chunks can be based on a maximum chunk size supported by the cloud platform. For example, if the maximum chunk size supported by the Amazon S3 platform were 5 GB, and the changed chunk size were 10 GB, then the backup and restore layer 204 can upload two changed chunks of 5 GB each. The backup and restore layer 204 also updates, in the cluster, the combined sizes of the “File-3” and “File-4” with the value “<disk1-size-2>.” In addition, the time of the snapshot changes to “backup-epoch-2,” which refers to the time of the last backup.

The backup and restore layer 204 can, in a similar manner, update the metadata shown in FIG. 6 if additional subsequent backup requests are received for the same object. In some embodiments, if there are no changes in the object in a subsequent request to backup, the backup and restore layer 204 may not upload any changed data chunks to the bucket corresponding to the object.

The updated metadata shown in FIG. 6 can be used to restore the object to a previous snapshot of the object. The backup and restore layer 204 can present to the user or to the management module 202 a list of all the snapshots stored in the cloud platform. The backup and restore layer 204 can receive an identity of the selected snapshot from the user or the management module 202. If the selected snapshot is the first snapshot, then the backup and restore layer 204 can acquire the entire set of files (corresponding to the changed data chunks) matching the version IDs within the bucket, and restore the object. The backup and restore layer 204 can restore the object to any one of the cloud platforms 214, and not just to the cloud platform on which the object and the changed data chunks are stored. Because the backup and restore layer 204 stores the object metadata at the node or the private cluster, the metadata can be used to access the appropriate objects or chunks from the cloud platform and restore the objects at the desired cloud platform.

For restoring objects that have changed after the first snapshot, the backup and restore layer 204 can build or restore the object at the cloud platform where the object is backed up along with the changed data chunks. However, unlike traditional systems, where the backup and restore layer 204 may have to be running on the cloud platform, the backup and restore layer 204 can instead run in the cluster. This reduces latency in the system, and reduces the costs associated with running the backup and restore layer 204 on the cloud platform.

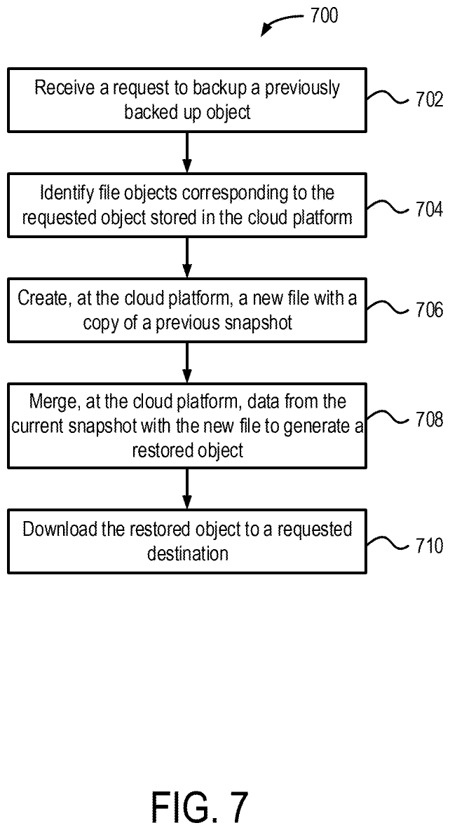

FIG. 7 shows an a flow diagram of an example process 700 for restoring objects. In particular, the process 700 discusses restoring objects that have changed after the first snapshot. The process includes receiving a request for restoring a previously backed up object (operation 702). For example, the backup and restore layer 204 can receive requests for restoring a previously backed up object from the management module 202. The request for restoring a previously backed up object can be received after the backup and restore layer 204 provides the user of the management module 202 a list of all the snapshots of all the backed up objects. For example, the backup and restore layer 204 can use the metadata stored in the cluster (such as that shown in FIG. 6) to provide the user with the number of snapshots that have been backed up in the cloud platform along with information regarding the time the snapshots were taken and the corresponding sizes of the changed chunks. Based on this information, the user or the management module 202 can select the snapshot to be restored.

The backup and restore layer 204 can identify the unique identifier associated with the object that the user has selected to restore. For example, referring to FIG. 6, if the user selected to restore the volume group, then the backup and restore layer 204 can identify the value “<vg-uuid>” as the unique identifier associated with the volume group. The backup and restore layer 204 can utilize the unique identifier to identify the metadata stored in the cluster, identify the cloud platform on which the corresponding objects are stored, and include the unique identifier in the requests sent to the cloud platform.

The backup and restore layer 204 can determine all the version IDs corresponding to the snapshots that need to be restored. For example, referring to FIG. 6, the backup and restore layer 204 can determine six version IDs, each corresponding to a changed chunk stored in the cloud platform. For each version ID, the backup and restore layer 204 can determine the corresponding file object stored in the bucket associated with the object (operation 704). For example, referring again to FIG. 6, the backup and restore layer 204 can determine six files “File-1,” “File-2,” “File-3,” “File-4,” “File-5,” and “File-6,” associated with the volume group object.

The backup and restore layer 204 can create a new file with a copy of the previous snapshot stored in the cloud platform (operation 706). The backup and restore layer 204 can utilize the value of the “<backup-epoch-n>” variable to determine the previous snapshot associated with the requested object stored in the cloud platform. Referring to FIGS. 4 and 6, the backup and restore layer 204 can determine that the previous snapshot (“<snapshot-uuid-1>”) was taken at time indicated by the value of the “<backup-epoch-1>” variable. Based on this determination, the backup and restore layer 204 can send requests to the cloud platform for creating a new file that includes a copy of the previous snapshot. In particular, the backup and restore layer 204 can request the cloud platform to create the new file using APIs provided by the cloud platform. The backup and restore layer 204 may also use a software development kit, or use command line commands to send the request to the cloud platform. As shown in FIG. 4, the previous snapshot was stored in the cloud platform as two files: “File-1” and “File-2,” corresponding to the two version IDs “<amz-versionid-1>” and “<amz-versionid-2>,” respectively. The backup and restore layer 204 can request the cloud platform to create a new file for each separate portion of the snapshot stored in the cloud platform. The backup and restore layer 204 can receive an acknowledgement from the cloud platform that the new file or files including the copy of the previous snapshot has been created.

The backup and restore layer 204 can request the cloud platform to merge the data of the current snapshot with the new file (operation 708). Using multi-part upload copy APIs, the backup and restore layer 204 can request the cloud platform to apply the file object data to the new file For example, the backup and restore layer 204 can utilize the upload-data-copy S3 API to merge the data associated with “changed-chunk-1” and the “changed-chunk-2” (stored in “File3” and “File4”) with the data of the previous snapshot in the new file. The merge operation can generate a first merged file, that can include the restored snapshot. The backup and restore layer 204 can also generate a second merged file based on the If the backup and restore layer 204 determines that the file size identified by the “disk1-size-1” attribute is less than the size of the previous snapshot, then the new file discussed above can be truncated at the value of “disk1-size-1”. The backup and restore layer 204 can repeat the merge operations described above for every disk identified by the “vg-diskn-uuid,” such as, for example, the two disks identified by the “vg-disk1-uuid” and “vg-disk2-uuid” shown in FIGS. 4 and 6. The backup and restore layer 204 can send additional commands to combine the merged files associated with the identified disks into a single restored object.

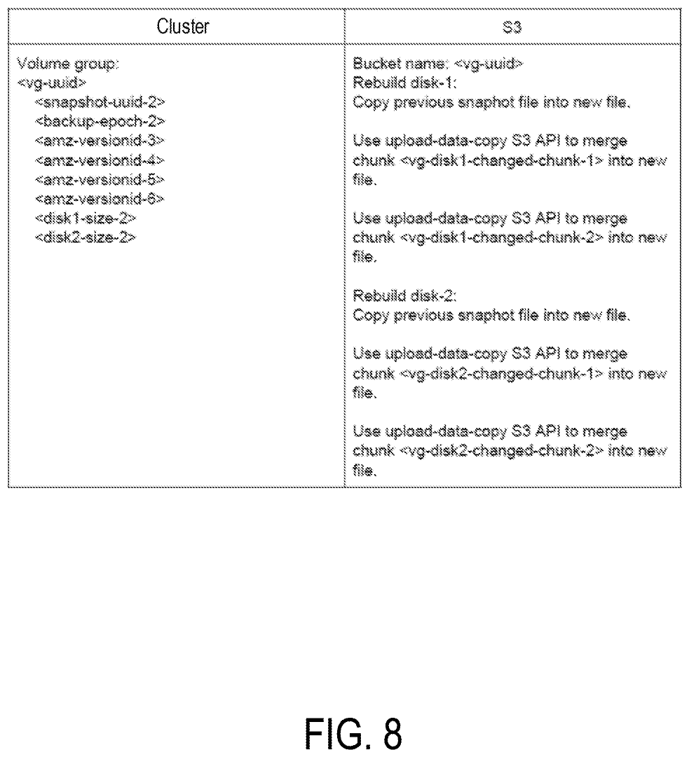

Once all the changes are applied to the new file, the restored object can be downloaded to the point of restoration (operation 710). That is the backup and restore layer 204 can download the restored object to the private cloud platform, or to another cloud platform. FIG. 8 shows an example operation flow that can be used for restoring a snapshot. In particular, FIG. 8 shows the metadata at the cluster in the left column and the operations performed at the cloud platform for restoring the volume group.

In one or more embodiments, the backup and restore layer 204 can send instructions to the cloud platform to generate the restored object from previously stored restored objects. That is, the changed chunks can be merged to a previously restored object corresponding to a snapshot, instead of merging changed chunks all the way back with the original snapshot. This operation can save restoration time, as well as computation burden. In one or more embodiments, the backup and restore layer 204 can modify the metadata such that the metadata associated with each changed data chunk has a pointer to the previous snapshot from which the changed data chunk was computed. Referring again to FIG. 8, the right column incudes upload operations that can be used to merge changed data chunks into an existing snapshot of the object. The backup and restore layer 204 can download the restored object to the cluster or to another cloud platform other than the cloud platform on which the snapshots were stored. Furthermore, by running the restore and backup layer 204 at the cluster, the execution of the steps for restoration and backup is carried out at the cluster, instead of at the cloud platform. This can provide better performance and reliability, as the performance of the execution of the restore and backup layer at a cloud platform may be impacted by the possibility of lack of processing power at the cloud platform. In addition, by executing the backup and restore layer 204 at the cluster, the step-by-step operation of the backup or restore operations can be monitored for reliability based on the acknowledgements received from the cloud platform. This may not be possible if the backup and restore layer 204 were to execute at the cloud platform. Moreover, by executing the backup and restore layer 204 at the cluster, the restored objects can be sent to cloud platforms other than the one on which the object was backed up. As a result, the restored object, such as a virtual machine, can be restored and run on a cloud platform with resources that are better suited to running a virtual machine than the resources at the cloud platform where the object was backed up that may be optimized for providing backup and storage operations.

Although the present disclosure has been described with respect to software applications, in other embodiments, one or more aspects of the present disclosure may be applicable to other components of the virtual computing system 100 that may be suitable for real-time monitoring by the user.

It is also to be understood that in some embodiments, any of the operations described herein may be implemented at least in part as computer-readable instructions stored on a computer-readable memory. Upon execution of the computer-readable instructions by a processor, the computer-readable instructions may cause a node to perform the operations.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A method comprising:
generating, by a computing system, a snapshot of an object for back up and at least one changed data chunk including changed data blocks in the object with respect to a previous snapshot of the object;
uploading, by the computing system, the object and the at least one changed data chunk into a bucket;
receiving, by the computing system, a response header including a plurality of version IDs corresponding to the information in the bucket;
generating, by the computing system, metadata associated with the object, the metadata including the plurality of version IDs;
and
in response to a request to restore the object, restoring, by the computing system, the object based on the metadata and the bucket.

2. The method of claim 1, wherein creating, by the computing system the bucket includes creating the bucket with a name that is same as a snapshot ID associated with the snapshot of the object.

3. The method of claim 1, wherein generating, by the computing system, metadata associated with the object, the metadata including the plurality of version IDs, includes storing at least one of a time of generating the snapshot, a snapshot ID associated with the snapshot, and a size of the object.

4. The method of claim 1, wherein the object includes at least one of a volume group, a virtual machine, a storage volume, an image, or a snapshot.

5. The method of claim 1, further comprising:
receiving, by the computing system, an identity of the previous snapshot with the request;
retrieving, by the computing system, changed data chunks associated with the plurality of version IDs included in the metadata; and
merging, by the computing system, the changed data chunks with the snapshot.

6. A method comprising:
receiving, at a computer system, a request to restore a backed up object stored on a cloud platform, the computer system and the cloud platform communicably coupled to the cloud platform over a computer network;
creating at least one new file with a copy of a previous snapshot associated with the backed up object at the cloud platform;
identifying, by the computer system, changed data chunks associated with the backed up object stored in the cloud platform;
merging the changed chunks with the at least one new file to generate a restored object; and
transferring the restored object to a requested destination.

7. The method of claim 6, wherein identifying changed data chunks associated with the backed up object stored in the cloud platform includes identifying, by the computer system, version IDs stored in metadata associated with the backed up object, the metadata stored at the computer system, each version ID corresponding to a changed data chunk stored on the cloud platform.

8. The method of claim 7, wherein creating the at least one new file includes creating a number of the at least one new file, wherein the number corresponds to a number of file objects in which the previous snapshot is divided into for storage on the cloud platform.

9. The method of claim 6, further comprising determining, by the computer system, that a size of the backed up object is less than a size of the previous snapshot, and wherein creating the at least one new file with the copy of the previous snapshot associated with the backed up object at the cloud platform includes copying a portion of the previous snapshot that is equal to the size of the backed up object to create the at least one new file.

10. The method of claim 6, wherein creating the at least one new file with the copy of a previous snapshot associated with the backed up object at the cloud platform includes using a pointer, stored in the backed up object, to the previous snapshot to access the previous snapshot.

11. A system comprising:
a controller communicably coupled to a plurality of cloud platforms, having programmed instructions to:
receive a request to back up an object to a cloud platform;
generate a snapshot of the object and at least one changed data chunk including changed data blocks in the object with respect to a previous snapshot of the object;
upload the object and the at least one changed data chunk into a bucket;
receive a response header including a plurality of version IDs corresponding to the information in the bucket;
generate metadata associated with the object, the metadata including the plurality of version IDs;
and
in response to a request to restore the object, restore the object based on the metadata and the bucket.

12. The system of claim 11, wherein the controller creates the bucket by creating the bucket with a name that is same as a snapshot ID associated with the snapshot of the object.

13. The system of claim 11, wherein the controller further stores at least one of a time of the generation of the snapshot, a snapshot ID associated with the snapshot, and a size of the object.

14. The system of claim 11, wherein the object includes at least one of a volume group, a virtual machine, a storage volume, an image, or a snapshot.

15. The system of claim 11, wherein the controller further:
receives an identity of the previous snapshot with the request;
retrieves changed data chunks associated with the plurality of versions IDs included in the metadata; and
merges the changed data chunks with the snapshot.

16. A system comprising:
a controller communicably coupled to a plurality of cloud platforms, having programmed instructions to:
receive a request to restore a backed up object stored on a cloud platform of the plurality of cloud platforms, the computer system and the cloud platform communicably coupled to the cloud platform over a computer network;
create at least one new file with a copy of a previous snapshot associated with the backed up object at the cloud platform;
identify changed data chunks associated with the backed up object stored in the cloud platform;
merge the changed chunks with the at least one new file to generate a restored object; and
transfer the restored object to a requested destination.

17. The system of claim 16, wherein the controller further identifies version IDs stored in metadata associated with the backed up object, the metadata stored at the computer system, each version ID corresponding to a changed data chunk stored on the cloud platform.

18. The system of claim 16, wherein the controller further creates a number of the at least one new file, wherein the number corresponds to a number of file objects in which the previous snapshot is divided into for storage on the cloud platform.

19. The system of claim 16, wherein the controller further determines that a size of the backed up object is less than a size of the previous snapshot,
and copy a portion of the previous snapshot that is equal to the size of the backed up object to create the at least one new file.

20. The system of claim 16, wherein the controller further accesses the previous snapshot based on a pointer, stored in the backed up object, to the previous snapshot.
